(19) United States
(12) Patent Application Publication
(10) Pub. No.: US 2022/0339673 A1
(43) Pub. Date: Oct. 27, 2022

(54) SORTING METHOD

(71) Applicant: Polysecure GmbH, Freiburg (DE)

(72) Inventor: Jochen MÖßLEIN, Freiburg (DE)

(21) Appl. No.: 17/761,320

(22) PCT Filed: Sep. 23, 2020
(86) PCT No.: PCT/DE2020/100822

§ 371 Date: Mar. 17, 2022

(30) Foreign Application Priority Data
Sep. 23, 2019 (DE) 10 2019 125 464.7

(51) Int. Cl. B07C 5/34; B07C 5/36

(52) U.S. Cl. CPC B07C 5/3412; B07C 5/36; B07C 2501/0054

(57) ABSTRACT

The invention relates to a sorting method comprising the steps of:
a. optionally, providing a plurality of objects;
b. singulating the objects;
c. analyzing the singulated objects, wherein at least one material property is respectively detected for the objects;
d. comparing the detected material property(ies) with reference material properties stored in a database, to which a target address is respectively assigned and detecting the fraction affiliation of the objects; and
e. sorting the singulated objects according to the target address assigned to their detected material property(ies) via one of the reference material properties in the database.

### TECHNICAL FIELD

The invention is based on a Sorting method for sorting a mixture of materials.

### BACKGROUND

Such a method is described in EP 2 828 053 B1.

WO 2017/220079 A1 describes a method for identifying materials in a previously mentioned mixture of materials by means of luminescence, wherein at least one luminescent substance can be introduced into the material and/or applied to the material. The luminescence behaviour of the substance is analyzed after excitation by means of radiation and can be used to identify the material, for example for the purpose of sorting, recycling and/or for another authentication or quality control. The luminescent substance can, for example, comprise a fluorescent compound which comprises anti-Stokes crystals or anti-Stokes pigments. With the aid of the known technologies, it is possible to impart an individual fingerprint to an object by admixing or by applying the previously mentioned luminescent materials, so that an object can be unambiguously identified by analysis of the luminescence behaviour.

Worldwide, the need to supply materials to the circular economy grows. For this purpose, the materials have to be identified and separated in a single variety. The single-variety separation is decisive for a high-quality recycling of the materials, since the material composition determines the processing and performance properties of the products.

However, a plurality of objects with very similar but not identical material properties are on the market. For example, objects can consist of a substantially identical base material (e.g. PP), but can contain different additives or structural properties depending on the intended use. A mixing and joint recycling of such objects has to be avoided, since the different additives and structural properties prevent a joint high-quality recycling on the basis of the above-mentioned influencing of production and performance. Furthermore, there is a need to separate materially identical objects according to their intended use.

For example, food packagings and non-food packagings which consist of the same material should be separated from one another in a single variety, since a higher quality is required for plastics in food packagings. A further challenge consists in the separation of packagings with a multilayer structure of packagings from only one plastics layer. Furthermore, there is a desire to sort substantially identical objects from different manufacturers by manufacturer, since manufacturers can have an interest in receiving and recycling the material which they themselves have circulated. In summary, there is a great need to separate the enormous multiplicity of object and material classes into single-variety fractions.

In sorting installations according to the prior art, it is possible to separate the material fractions aluminum, tinplate, paper/cardboard/cardboard (PPK) and plastic by using a variety of methods (for example drum screening, wind screening, ballistics separation, magnetic separation, eddy current separation and NIR (near infrared) detection). Furthermore, the plastics can be separated into the main polymers HDPE (high density polyethylene), LDPE (low density polyethylene), PP (polypropylene), PS (polystyrene), PET (polyethylene terephthalate) and PVC (polyvinyl chloride). However, a more extensive sorting according to the above-described requirements is not possible.

### SUMMARY

It is therefore the object of the invention to further develop a sorting method of the type described in the introduction in such a way that it allows a more extensive sorting on the basis of additional criteria.

This object is achieved by a sorting method having the features of claim 1. The dependent claims relate in each case to advantageous embodiments of the invention.

Accordingly, it is provided in a sorting method that it comprises the steps of:

a. optionally, providing a plurality of objects;
b. singulating the objects;
c. analyzing the singulated objects, wherein at least one material property is respectively detected for the objects;
d. comparing the detected material property(ies) with reference material properties stored in a database, to which a target address is respectively assigned and detecting a fraction affiliation of the objects; and
e. sorting the singulated objects according to the target address assigned to their detected material property via one of the reference material properties in the database.

The fraction affiliation within the meaning of the invention describes the property of a material or object to be part of a material/object fraction, wherein all parts of this material/object fraction have common properties. These properties can be e.g. a material type (e.g. PE), an origin (e.g. manufacturer of the material), an application (e.g. food packaging) or any other property (e.g. content of a specific additive). The parts of a material/object fraction can also have a joint combined properties (e.g. PE of a specific manufacturer).

The method according to the invention can be applied in particular in material recycling, in waste sorting and in material recovery.

The analyzing can comprise detecting a material property applied to the object and/or introduced into the object, for example detecting a fluorescence code and/or a watermark and/or a barcode and/or a QR code and/or a symbol and/or an article number and/or detecting a native material property of the object, for example a chemical material composition of the object and/or a colour and/or a shape of the object.

Thus, for example, the spectroscopically analyzable luminescence spectrum of an object can have an unambiguous characteristic, which makes it possible, for example by assigning a target address stored in a database, to supply the object to an unambiguous sorting target, for example in order to make it available again to the manufacturer of the relevant object for recycling purposes. An individualization of the spectroscopically analyzable emitted spectrum can be effected by applying or admixing a luminescent marker, as described for example in EP 2 828 053 B1, in order to further increase the distinguishability of individual objects within the plurality of objects provided in a pulk-shaped manner.

The analyzing can comprise spectroscopically analyzing, in which the luminescence marker of one of the singulated objects is electromagnetically excited in order to analyze its remitted spectrum. The luminescence marker can in this case comprise at least one material that emits with at least one emission wavelength or with a plurality of emission wavelengths after the exciting. In addition to different luminescence markers, mixtures of different luminescence markers can also be used, wherein the mixtures can contain different quantitative ratios of the individual luminescence materials, so that a further distinguishing feature that can be metrologically analyzed is created via the intensity distribution of the emitted spectrum.

The analyzing can comprise electromagnetically exciting a luminescence marker, wherein a material of the marker can comprise a luminescent material, e.g. a fluorescent material and/or a phosphorescent material and/or an upconverter and/or a downconverter.

The analyzing can comprise spectroscopy of at least one luminescent material of the singulated objects, e.g. on a conveyor.

The sorting of the singulated objects can comprise addressing a support means of the conveyor to which exactly one of the singulated objects is assigned, whereby the singulated object is supplied to the target address.

The addressing can comprise driving at least one transmittal of a plurality of independently drivable support means of a conveyor. The conveyor can be, for example, a cross belt sorter with a plurality of linked conveyor belts that are independently drivable or a drop flap sorter with a plurality of independently drivable drop flaps.

The analyzing can comprise detecting a property applied to the object or introduced into the object, for example detecting a fluorescence code, a watermark, a bar code, a QR code, a symbol and/or an article number. Alternatively, the spectroscopic analyzing can comprise detecting a native property of the object, for example a chemical material composition of the object and/or a shape of the object.

After the comparing and before the sorting, a support means of the conveyor to which exactly one of the singulated objects is assigned can be assigned the target address linked via the detected material property of the singulated object in the support means and the reference material property.

In the event that during the comparing of the detected material property with the reference material properties stored in the database, no reference material property is found which is identical to the detected material property, during the sorting of the affected object, a standard address can be assigned to the object or the affected object can be fed once again to the singulation and thus once again to the analysis.

The analyzing can comprise analyzing at least one luminescence marker arranged on the object or in the object or a plurality of markers differing in at least one detectable luminescence property, wherein the plurality of markers, for example of a mixture of markers, can also differ from one another with respect to their quantity ratio.

A printing ink comprising a fluorescent code can have been applied to at least one of the provided objects. The printing ink can be, for example, white printing ink, for example in a partial region of a printing of a label or a shrink film of the object. The printing ink can also be provided in the form of a direct printing of the object, for example if the object is a packaging.

A label adhesive comprising a fluorescent code or a label lacquer comprising a fluorescent code can have been applied to at least one of the provided objects before the providing.

Before the providing, a label or a shrink film can be applied to the object, which has a fluorescence code in its base material.

Before the providing, the object can be produced from a base material, for example from a plastic material which has a material admixture comprising a fluorescence code.

The analyzing can comprise determining an intensity for one or for several emission wavelengths of the emitted spectrum and/or determining the intensity for one or for several emission wavelength ranges of the spectrum and/or determining an intensity ratio between several emission wavelengths or several emission wavelength ranges of the spectrum and/or determining the intensity of an emission spectrum and/or of a dynamic emission behaviour.

The analyzing can comprise sequentially passing the singulated objects through a tunnel-shaped or tubular detection module, on the inner wall of which at least one sensor for detecting the emitted spectrum is arranged.

The passing can comprise passing the singulated objects through the tubular or tunnel-shaped detection module in a gravity-driven manner. For this purpose, the tubular or tunnel-shaped detection module can be aligned with its axis of symmetry, along which it is permeable, in the vertical direction or substantially in the vertical direction.

The analyzing of the singulated objects can comprise analyzing with a plurality of mutually independent detection modules. In this case, it can be provided that the analyzed objects are supplied to a separate sorter per detection module. The sorter can be, for example, a cross belt sorter, a drop flap sorter or the like. In this case, it can be provided that the sorters feed the same plurality of transport devices according to the target address, so that the objects can be supplied from the transport devices to one of the target address respectively in each case.

The analyzing, the comparing and the sorting of the singulated objects can be carried out multiple times, in particular in a plurality of successive partial steps. In this case, at least one first emitted spectrum can be used in a first analysis step and at least one further emitted spectrum can be detected in at least one further analysis step. After the first analysis step and a first comparing step, a first part of the target address can be assigned and after the at least one further analysis step and the at least one further comparing step, at least one further part of the target address can be assigned. In this case, it can be provided that the object is supplied to the target address after passing through all analysis steps and all comparing steps and after assigning all parts of the target address.

The analyzing, the comparing and the sorting of the singulated objects can be carried out multiple times, wherein at least one first material property of one of the singulated objects is detected in a first analysis step and a first part of the target address is assigned after the comparing. In this case, the singulated object after the assigning via a transport system can be supplied to the target address or at least one further detection module for a further analysis step at least one of the first different further material properties can be supplied and after the matching a further part of the target address can be assigned. Finally, after the assigning of all parts of the target address, the object can be supplied to the target address.

### DETAILED DESCRIPTION

The material properties analyzed according to the invention of the singulated objects can be provided as markers in the form of fluorescence codes. For the provision of corresponding fluorescence codes, exemplary embodiments are specified below:

### Exemplary Embodiment 1

For the production of different fluorescence codes, three luminescence materials are mixed with one another. The luminescence materials have the same excitation wavelength, but have different emission wavelengths, wherein marker 1 emits at wavelength λ1, marker 2 at wavelength λ2, and marker 3 at wavelength λ3. The mass fractions of the individual materials in the total mixture in this example are 0%, 25%, 50%, 75% or 100%. This results in 15 fluorescence codes:

| | | | | | | | Intensity ratio |
|---|---|---|---|---|---|---|---|
| Fluorescence | Mass fractions | | | Emission wavelength | | | Marker 1:Marker |
| code | Marker 1 | Marker 2 | Marker 3 | λ1 | λ2 | λ3 | 2:Marker 3 |
| C1 | 100% | 0% | 0% | + | | | 1:0:0 |
| C2 | 75% | 25% | 0% | + | + | | 3:1:0 |
| C3 | 50% | 50% | 0% | + | + | | 1:1:0 |
| C4 | 25% | 75% | 0% | + | + | | 1:3:0 |
| C5 | 0% | 100% | 0% | | + | | 0:1:0 |
| C6 | 75% | 0% | 25% | + | | + | 3:0:1 |
| C7 | 50% | 25% | 25% | + | + | + | 2:1:1 |
| C8 | 25% | 50% | 25% | + | + | + | 1:2:1 |
| C9 | 0% | 75% | 25% | | + | + | 0:3:1 |
| C10 | 50% | 0% | 50% | + | | + | 1:0:1 |
| C11 | 25% | 25% | 50% | + | + | + | 1:1:2 |
| C12 | 0% | 50% | 50% | | + | + | 0:1:1 |
| C13 | 25% | 0% | 75% | + | | + | 1:0:3 |
| C14 | 0% | 25% | 75% | | + | + | 0:1:3 |
| C15 | 0% | 0% | 100% | | | + | 0:0:1 |

The fluorescence codes differ with respect to the emitted emission wavelengths and the luminescence intensity at the emission wavelengths. The different luminescence intensities lead to different intensity ratios between the emission wavelengths.

### Exemplary Embodiment 2

Bottles made of PET and shrink films made of PET-G are to be sorted into separate containers. The bottles do not contain a fluorescence code, the shrink films contain the fluorescence code “C8”. The objects are singulated and analyzed by a detection module by means of NIR spectroscopy and fluorescence spectroscopy. By means of NIR spectroscopy, the material property “PET” is detected for the bottles and shrink films. By means of fluorescence spectroscopy, the material property “Contains fluorescence code C8” is detected only for the shrink films. In a database, the target address “Container A” is stored for materials with the material property “PET” and the target address “Container B” is stored for materials with the combined material properties “PET and fluorescence code C8”. After the analysis of a PET bottle with detection of the material property “PET”, the PET bottle is placed onto its own carrier means of a drop-down type sorter. By comparing the detected material property “PET” with the database, the target address “Container A” is assigned to this carrier means. The carrier means is transported to container A and emptied there. After the analysis of a shrink film with detection of the material properties “PET and fluorescence code C8”, the shrink film is placed onto its own carrier means of a drop-down type sorter. By comparing the detected material property “PET and fluorescence code C8” with the database, the target address “Container B” is assigned to this carrier means. The carrier means is transported to container B and emptied there.

### Exemplary Embodiment 3

Three types of packaging made of identical base material are used in different economic sectors. Type 1 serves for the packaging of foodstuffs. Type 2 serves for the packaging of cleaning agents. Type 3 serves for the packaging of coolant. The packagings of all types are to be separated from one another. Type 1 contains a label with fluorescence code C2 in the printing ink of the label. Type 2 contains a label with fluorescence code C14 in the label varnish. Type 3 contains the fluorescence code C10 in the printing ink of an inscription printed directly onto the packaging. The objects are singulated and analyzed by a detection module by means of wavelength-specific photodiodes.

After the analysis of the singulated objects, these are placed individually in each case onto its own carrier means of a drop-down type sorter. By comparing the detected fluorescence codes of the objects with the fluorescence codes stored in the database and the target addresses linked thereto, the corresponding target address is assigned to the carrier means. The carrier means are transported to the respective containers and emptied there.

### Exemplary Embodiment 4

PE bottles from 8 manufacturers are intended to be separated in a single variety. The PE bottles of manufacturers 1 and 2 carry labels with the manufacturer-specific fluorescence codes C1 and C2. The PE bottle of manufacturer 3 contains a manufacturer-specific fluorescence code C3 in the base material of the bottle. The PE bottle of manufacturer 4 carries a label with a QR code, the PE bottle of manufacturer 5 carries a label with a characteristic symbol, the PE bottle of manufacturer 6 carries a label with a watermark, the PE bottle of manufacturer 7 carries a label with a code readable by X-ray fluorescence analysis (RFA). The PE bottles of manufacturers 1-7 have the same shape, manufacturer 8 uses a PE bottle with a characteristic shape. In addition to the mentioned PE bottles, further PE bottles of unknown manufacturers are located without the above-mentioned features and objects made of PP or metal.

The objects are singulated and analyzed by a detection module by means of fluorescence spectroscopy, devices for optical image recognition, X-ray fluorescence spectroscopy, NIR spectroscopy and metal detectors. By means of fluorescence spectroscopy, the material properties “Contains fluorescence code C1/C2/C3” are detected. By means of optical image recognition, the material properties “Contains QR code of manufacturer 4”, “Contains symbol of manufacturer 5”, “Contains watermark of manufacturer 6” and “PE bottle possesses characteristic shape of manufacturer 8” are detected. By means of X-ray fluorescence analysis, the material property “Contains RFA code of manufacturer 7” is detected. By means of NIR spectroscopy, the material properties “PE” and “PP” are detected for the objects. By means of metal detection, the material property “Contains metal” are detected for the objects. In a database, the following target addresses are stored for the material properties:

| Material property | | | | | | | | | | | |
|---|---|---|---|---|---|---|---|---|---|---|---|
| | | | QR | Symbol | Watermark | RF code | Bottle shape | | | | |
| Fluorescence code | | | manufac- | manufac- | manufac- | manufac- | manufac- | | | | Target |
| C1 | C2 | C3 | turer 4 | turer 5 | turer 6 | turer 7 | turer 8 | PE | PP | Metal | address |
| + | | | | | | | | + | | | H1 |
| | + | | | | | | | + | | | H2 |
| | | + | | | | | | + | | | H3 |
| | | | + | | | | | + | | | H4 |
| | | | | + | | | | + | | | H5 |
| | | | | | + | | | + | | | H6 |
| | | | | | | + | | + | | | H7 |
| | | | | | | | + | + | | | H8 |
| | | | | | | | | | + | | PP |
| | | | | | | | | + | | | PE |
| | | | | | | | | | | + | ME |
| | | | | | | | | | | | 0 |

After the analysis of the singulated objects, these are placed individually in each case onto its own carrier means of a drop-down type sorter. By comparing the detected material properties of the objects with the database, the corresponding target address is assigned to the carrier means. The carrier means are transported to the respective containers and emptied there. In this way, the PE bottles of manufacturers 1, 2, 3, 4, 5, 6, 7 and 8 are transported in each case to the containers H1, H2, H3, H4, H5, H6 and H8. PE bottles for which only the material property “PE” has been detected arrive at container PE. Objects made of PP are transported to container PP. Objects for which no material property whatsoever has been detected which is stored in the database are transported to container 0.

### BRIEF DESCRIPTION OF THE DRAWINGS

Further details of the invention are explained on the basis of the figures below. In the figures:

FIG. 1 shows a sorting method according to the prior art;

FIG. 2 shows a first embodiment of a sorting method according to the invention;

FIG. 3 shows an exemplary embodiment of the assignment of a target address to an object;

FIG. 4 shows a further embodiment of a sorting method according to the invention;

FIG. 5 shows yet a further embodiment of a sorting method according to the invention;

FIG. 6 shows yet a further embodiment of a sorting method according to the invention;

FIG. 7 shows an exemplary embodiment for sorting out undetected objects; and

FIG. 8 shows a method for returning undetected objects.

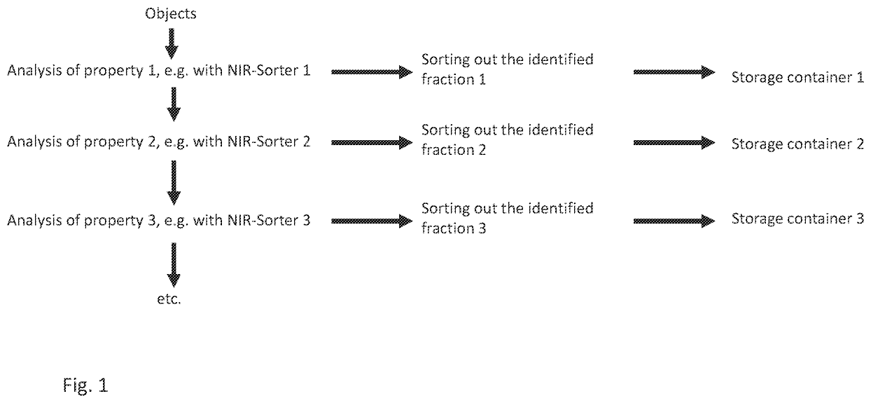

The FIG. 1 illustrates a sorting method according to the prior art. These methods are distinguished, in particular, in that the identification and the sorting of the objects, for example on the basis of material fractions, is carried out sequentially, wherein only a single fraction can be identified and sorted out in each sorting step. The identification is based here on material properties of the objects. This has the consequence that only a few specifications can be distinguished, for example a distinction can be made merely on the basis of the main polymers polyethylene, polypropylene, polystyrene, polyethylene terephthalate, polyvinyl chloride, etc. The known sorting methods are inefficient in this respect, in particular with regard to the distinguishability provided, which goes beyond the differentiation of the previously mentioned materials.

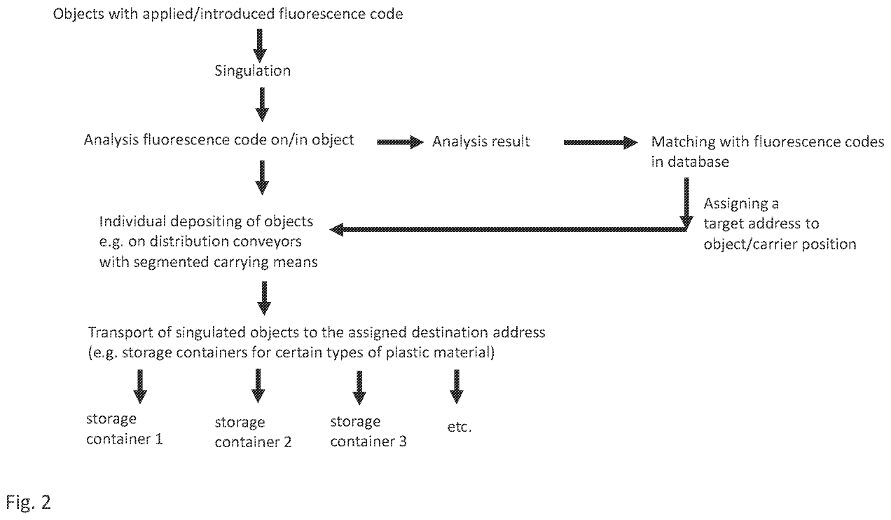

The FIG. 2 therefore proposes, in an exemplary embodiment, a method in which the objects taken as a basis for the sorting have at least partially an applied, introduced or admixed luminescent code, for example a fluorescence code. The objects can be provided, for example, in a pulk-shaped manner, so that these are firstly singulated in a first step for optimizing the analysis result. The singulated objects are then subjected to an analysis of the fluorescence code, wherein the analysis result is subjected to a comparison with reference fluorescence codes which are stored in a database, wherein the reference fluorescence codes are assigned target addresses in the database. The target addresses can be different storage containers into which only specific material fractions, e.g. only specific plastic types or only specific objects of specific manufacturers are to be sorted. The fraction affiliation of the analyzed objects is thus detected by the comparison between analysis result and reference fluorescence codes.

After the comparison, the target address can consequently be assigned to the analyzed object or a carrier means of a conveyor, for example a transport container of a drop-down type sorter, a segment of a cross belt sorter or the like. The objects singulated on the sorter can thus be positioned, for example, on a distributing conveyor with segmented carrier means, whereby it is made possible to transport the individual objects with the assigned target address to the assigned target address, for example to a storage container for specific plastic types of a specific manufacturer or to an otherwise specific addressee.

In contrast to the prior art, the identification and sorting of the objects thus takes place according to a luminescence marker code on or in the objects. The identification and sorting of the material fraction does not take place sequentially, but in a single step. The identification is no longer based on the main material of the objects alone, for example PET. Rather, in addition or exclusively on the basis of e.g. luminescence marker codes, any specifications can be distinguished. This also makes possible, for example, the sorting according to manufacturer, according to brand, field of application or any other criterion which is linked to the object via the luminescence markers. The described method thus makes possible a sorting of objects into different fractions with strictly delimited specifications and thus ensures the fraction affiliation of the objects sorted to the individual fractions.

The introduction or application of a fluorescence code can include the application of a luminescence marker. The luminescence marker in turn can comprise a luminescent material, e.g. a fluorescent material and/or a phosphorescent material and/or an upconverter and/or a downconverter and/or at least one material which remits after excitation of an excitation wavelength.

A luminescent material is understood to mean a material which emits electromagnetic radiation after input of energy. It is preferred here that the energy input takes place via photons, the observed luminescence is thus photoluminescence. The photoluminescence can occur in the UV and/or VIS and/or IR. Upconverters are luminescent substances which emit photons after excitation, the wavelength of which is shorter than the wavelength of the excitation photons. Downconverters are luminescent substances which emit photons after excitation, the wavelength of which is longer than the wavelength of the excitation photons.

Depending on the type of the desired discrimination capability, one luminescence marker or a plurality of luminescence markers which differ from one another in at least one property can be used. A plurality of different markers can be provided, for example, in the form of a mixture of markers with a different quantity of one or more markers. A mixture of markers can also be defined by the quantitative ratios between a plurality of markers.

The fluorescence code or the luminescence marker can be admixed to a printing ink, for example in white printing ink. The printing ink can be provided, for example, in a partial region of the printing which an object has in any case. Alternatively or additionally, the printing ink can be provided for the printing of a label, a shrink film or the like of the object. Furthermore, the printing ink can be used for the direct printing of, for example, a packaging. Alternatively or additionally, the fluorescence code or the luminescence marker can be provided in a label adhesive, in a lacquer for a label or a packaging material, in a base material of a label or shrink film, or in the base material of the object, e.g. in a plastic of a plastic bottle.

For the singulation of the arrangement of objects supplied in a pulk-shaped manner, any desired apparatus for singulating the objects can be provided. This can comprise, for example, a plurality of conveyor belts connected in series with increasing conveying speed, chicanes, a shaking device, a robot system, an infeed station with manual feeding or the like. In this case, the singulation can pursue the aim of positioning the objects arranged in series in the feed direction of a conveyor means. The further transport of the objects can take place with the aid of a distributing conveyor with segmented carrier means, but also with the aid of a distributing conveyor with continuous carrier means.

Before the singulation, the objects can be supplied to the sorting method mechanically from a collecting store. Alternatively, the objects can also be supplied by manual feeding. If the individual objects are supplied successively in this case, a singulation of the objects is achieved at the same time.

A distributing conveyor with segmented carrier means is a conveyor system in which each transported object is located at a defined place, e.g. in a trough-shaped receiving point. In the case of distributing conveyors with continuous carrier means, the objects are not located at defined places.

The singulation offers several advantages. On the one hand, only one object is examined during the analysis of the material properties. Object-specific analysis results can therefore be obtained. Without singulation, a plurality of objects with different material properties could be present simultaneously in the detection module, which would lead to mixed analysis results. Furthermore, the singulation makes possible a depositing of individual objects onto a segmented carrier means in each case and thus the targeted transport of individual objects to defined target locations.

After the objects have passed through the apparatuses for singulation, the presence of singulated objects can be controlled. This can take place by means of optical image recognition. In the case of detection of a plurality of objects and thus erroneous singulation, a pausing of the analysis process can be induced. The group of non-singulated objects then passes through the detection module without analysis and can subsequently be sorted out as unanalyzable or added again to the singulation step.

The analysis of the fluorescence code or the luminescence marker can take place with known methods of spectroscopy, which in the context of this application are to be understood to mean all methods and apparatuses which are suitable for analyzing an overall emission spectrum, a partial emission spectrum, wavelength ranges, individual emission wavelengths or a dynamic emission behaviour.

The analysis of the fluorescence code or the luminescence marker can comprise the analysis of the intensity for one or for several emission wavelengths of the fluorescence code and/or the analysis of the intensity for one or several emission wavelength ranges of the fluorescence code and/or the analysis of the intensity ratios between emission wavelengths or emission wavelength ranges and/or the analysis of an emission spectrum and/or the analysis of a dynamic emission behaviour. Following this, an assignment of a target address to the analyzed object can be carried out by comparing the analysis result with fluorescence codes stored in a database.

The dynamic emission behaviour is understood to mean the luminescence emission behaviour over time. For analysis, after the end of the luminescence excitation, the emission of the luminescence can be metrologically detected in a defined time period. After the excitation, the luminescence intensity for an emission wavelength or a wavelength range can be determined multiple times after defined time intervals. Intensity curves over time can be formed from the obtained absolute intensities. This can also be carried out for several emission wavelengths or wavelength ranges. Likewise, intensity ratios between different emission wavelengths or emission-wavelength-ranges can be formed. It is also preferred that the decay constant is determined for one or several emission wavelengths or wavelength ranges. The decay constant is understood to mean the time period in which the initial intensity of the emission drops to 1/e times.

For excitation of the luminescence, broad-band and/or narrow-band sources such as e.g. lasers, laser diodes, light-emitting diodes (LEDs), xenon lamps, halogen lamps can be used individually or in combination. The excitation sources can be activated individually or activated simultaneously or sequentially in different combinations. Optical filters such as long-pass/short-pass/bandpass filters can be used in the excitation devices. Furthermore, a variation of the opening width of the excitation sources can be provided in order to modulate the size of an excitation zone through which material to be identified is transported. The excitation zone can also be modulated in that a plurality of excitation sources are arranged sequentially one behind the other and the number of activated excitation sources in this arrangement is varied.

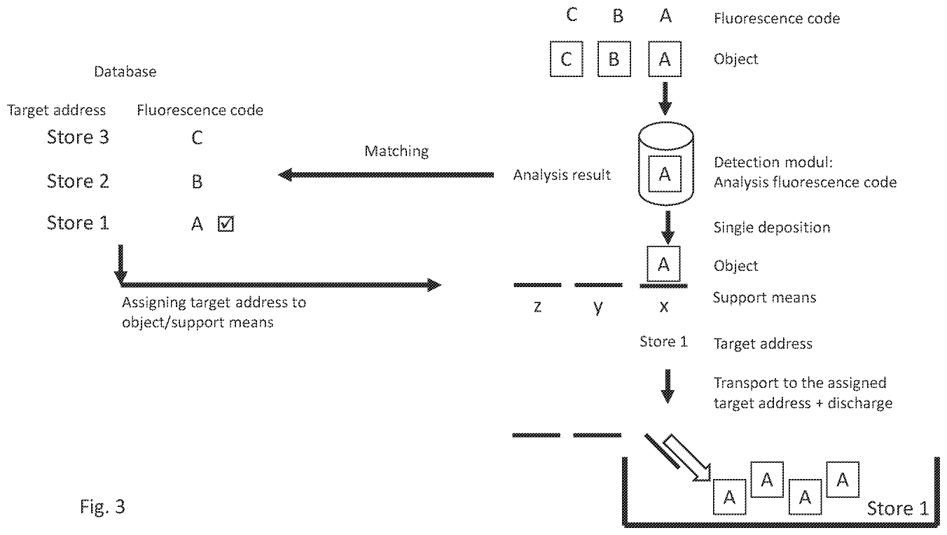

The FIG. 3 shows an exemplary embodiment of a method according to the invention, wherein it is already assumed in the embodiment that the objects have been singulated beforehand. The objects each have a fluorescence code A, B, C, which can be spectroscopically analyzed with the aid of a detection module. The analysis result is used in a comparing step to retrieve, with access to a database, a target address assigned to the detected fluorescence code from the database, which target address is assigned to the object as a result of the comparing. The fraction affiliation of the analyzed objects is thus detected by the comparing step. The assignment of the target address to the object can take place to the extent that the assignment to an individually drivable support means of the conveyor on which the objects are transported is assigned. The support means are individually drivable, for example in the manner of a cross belt sorter or in the manner of a drop flap sorter, whereby a supply of the object to the target address assigned to it or to its support means is possible/made possible, for example to a storage container for the single-variety and/or manufacturer-pure depositing of sorted objects.

In addition to the analysis of luminescent codes, the evaluation of other material properties, including labels of the objects for the differentiation of the objects, can also be accessed. A material property is to be understood within the scope of this invention to mean any property which can be used for differentiating object and material fractions and assigning objects and materials to these fractions. The differentiation can have for this purpose, for example, the analysis of labels on or in the objects such as article numbers, symbols, logos, image marks, bar codes, QR codes, watermarks, RFA codes and the like. Furthermore, an evaluation can follow the shape of the object. Furthermore, an analysis of material properties can take place in the narrower sense, for example the analysis of the colour or a chemical composition of the objects.

Watermarks are to be understood to mean, for the human eye, inconspicuous codings which are applied to the surface of objects, e.g. packagings. The detection of the watermarks takes place with camera systems. An RFA code is to be understood to mean a code which can be detected by means of X-ray fluorescence analysis (RFA). The RFA code can be formed e.g. by defined quantities of one or more chemical elements. Like the fluorescence code, the RFA code can also be admixed e.g. to a printing ink or can be provided in a label adhesive, in a lacquer for a label or a packaging material, in a base material of a label or shrink film, or in the base material of the object, e.g. in a plastic of a plastic bottle.

The detection technologies used can have a sensor system for luminescence analysis, an optical sensor system, for instance camera systems, VIS spectrometry, near-infrared spectrometry (NIR), X-ray sensor system (e.g. RFA), laser-induced plasma spectroscopy (LIPS), metal sensor system and the like.

For luminescence analysis, for example, different detectors such as black-and-white cameras, colour cameras, photomultipliers, spectrometers, photocells, photodiodes, phototransistors alone or in combination can be used. Furthermore, optical filters such as e.g. long-pass/short-pass/bandpass filters can be contained. The analysis result thus obtained can in turn be used in the manner already described above, after comparison with reference data in a database and target addresses assigned thereto, to detect the fraction affiliation of the analyzed object, to assign its intended target address to the analyzed object and, by individual storage of the objects, for example on a distributing conveyor with segmented carrier means, to supply the objects to the assigned target addresses.

The determination of the fraction affiliation and sorting of an object to a target address can be based not only on an analyzed material property, but also on a combination of several different material properties. In the database, reference data are stored for the individual material property combinations and linked to target addresses. The detected material property combination is compared with the reference material property combinations stored in the database. If the detected material property combination agrees with a reference material property combination, the target address assigned to the reference material property combination is assigned to the analyzed object. The analyzed object can thus be supplied to the assigned target address, which can be e.g. a specific collecting store. By detecting many different material properties, the number of distinguishable specifications can be increased.

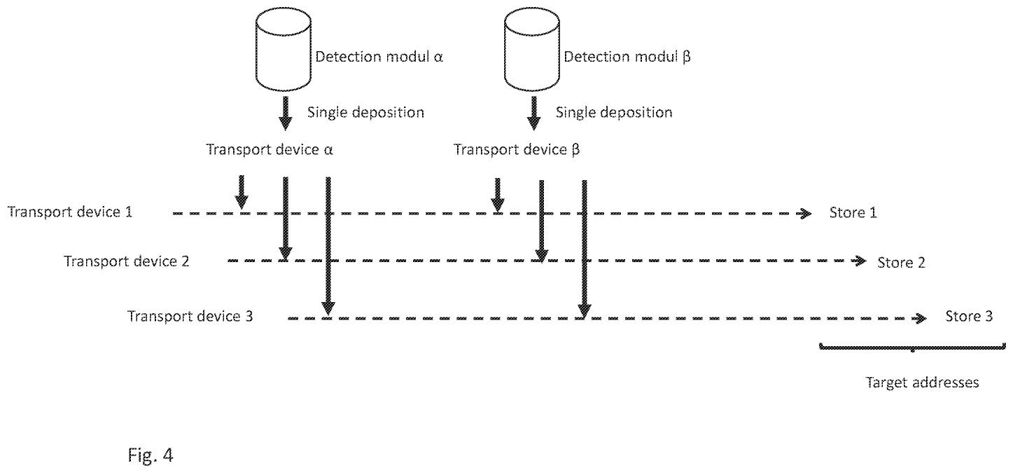

FIG. 4 shows an embodiment which shows the parallel operation of two detection modules α and β as well as the transport to three different target addresses. The transport devices α and β transfer the objects to the transport devices 1, 2 and 3, which feed the target addresses to store 1, store 2 and store 3. The transport devices α and β can be e.g. drop flap sorters and thus send objects to different target addresses, while the transport devices 1, 2 and 3 only drive specific target addresses. This leads to an increase in productivity. The individual storage of the objects analyzed in the detection modules α and β can take place on known sorters, for example drop flap sorters or the like. Accordingly, it can be provided that the analyzing of the singulated objects comprises analyzing with a plurality of mutually independent detection modules, of which the analyzed objects are supplied to a separate sorter per detection module. The sorters can in this case feed the same plurality of transport devices according to the target address, and the transport devices supply the objects to one of the target addresses in each case.

Alternatively, detection modules operated in parallel can also deposit the objects analyzed by them only onto a joint sorter, e.g. drop flap sorters. This sorter supplies the objects directly to the target addresses or feeds a plurality of transport devices, which lead the objects to one target address in each case. In this case, it has to be controlled which carrying means of the sorter are not yet occupied by an object, since the detection modules are only allowed to deposit analyzed objects in unoccupied carrying means. In the case of double occupancy of a carrying means with different objects by different detection modules, the assignment and the transport of the objects to a defined target address would be subject to errors. The control of the carrying means occupancy can take place by means of optical image recognition or light barriers. In the case of detection of a free carrying means, the subsequent detection module can be released and deposit the analyzed object onto the free carrying means. In the case of detection of an occupied carrying means, the subsequent detection module can be deactivated and retain the analyzed object until a free carrying means is available.

The detection modules can have a guide tube with substantially upright position, i.e. vertical passage direction. The objects can move through the detection module within the guide tube substantially in a gravity-driven manner. The sensor system for the analysis of the object properties can be arranged annularly in the guide tube.

Alternatively or additionally, it can be provided that the objects to be analyzed are actively conveyed within the detection modules, for example with the aid of a conveyor belt. The detection apparatuses of the detection modules for analyzing the object properties can be positioned above and/or below the transport device. Alternatively, the detection apparatuses for analyzing the object properties can be positioned above and/or below an object ejection. For example, the objects can be transferred within the detection module from a transport apparatus, e.g. conveyor belt, to a second transport apparatus, wherein a spatial gap is provided at the interface of both transport apparatuses. This gap is overcome by the objects in flight. The detection apparatuses for analyzing the object properties can be positioned above and/or below the gap. Likewise, the sensor system can also be positioned annularly around this gap. Several sides of the objects can hereby be analyzed.

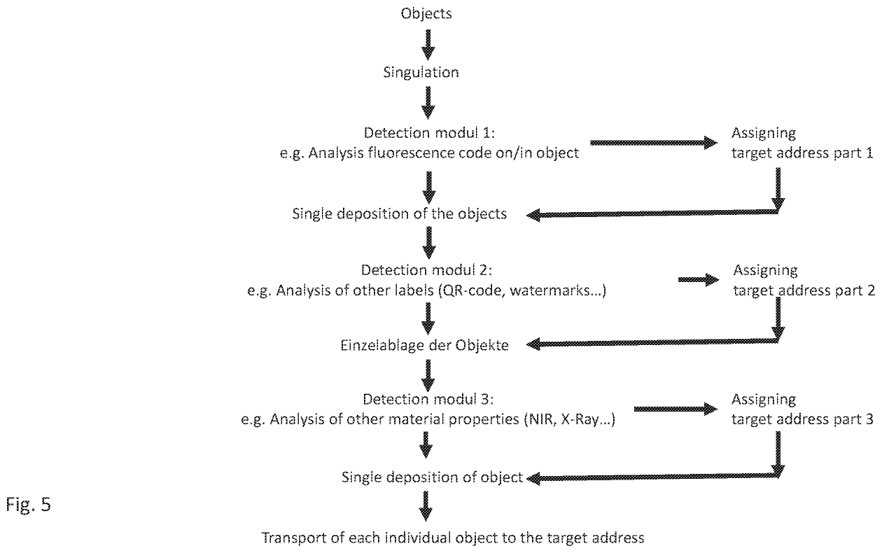

The FIG. 5 shows an embodiment in which the analysis of the singulated objects takes place in separate detection modules. For example, the detection modules can differ by the type of the evaluated code or the label or property. A first detection module can be provided, for example, for the analysis of a fluorescence code of the object. As a result of the detected fluorescence code, a target address assignment can take place in the already previously described manner by resorting to a database. In at least one of the subsequent detection steps with one of the further detection modules, in the present case the detection modules 2 and 3, a further label of the object can be evaluated, for example with the detection module 2 a QR code, a watermark or the like, wherein a further target address or a further target address part can in turn be assigned with access to a database to the same analyzed object. This can be repeated until the object has passed all detection modules and, if necessary, has been assigned a plurality of target addresses or partial addresses, which in their sum result in a final destination of the analyzed object, to which the analyzed object can then be supplied in the described manner.

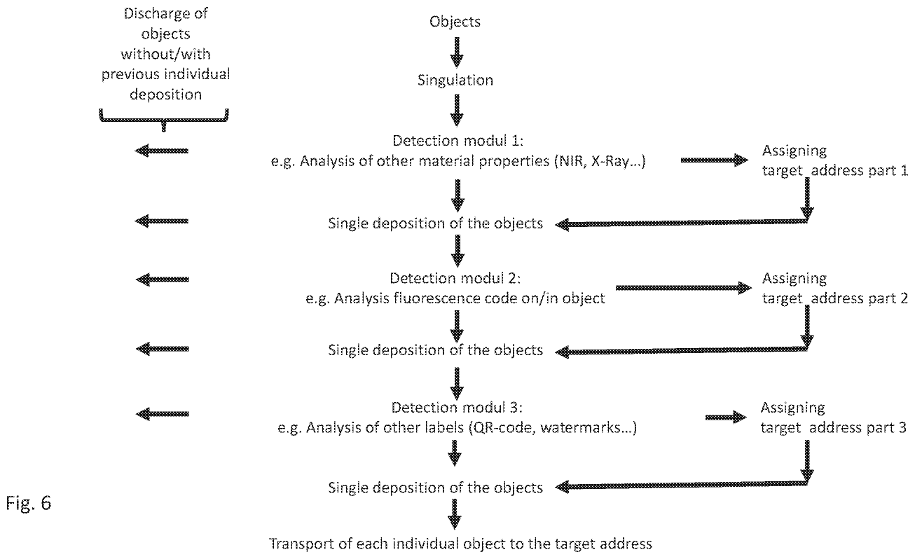

FIG. 6 shows a modification of the embodiment shown in FIG. 5 to the effect that objects which have experienced a positive assignment of a target address once after passing one of the detection modules 1 to 3 are already discharged from the process, so that the passing of the further detection modules no longer takes place and the object is in this respect already finally assigned after the one-time target address assignment, i.e. can already be supplied to its intended target address with reference to the assigned target address.

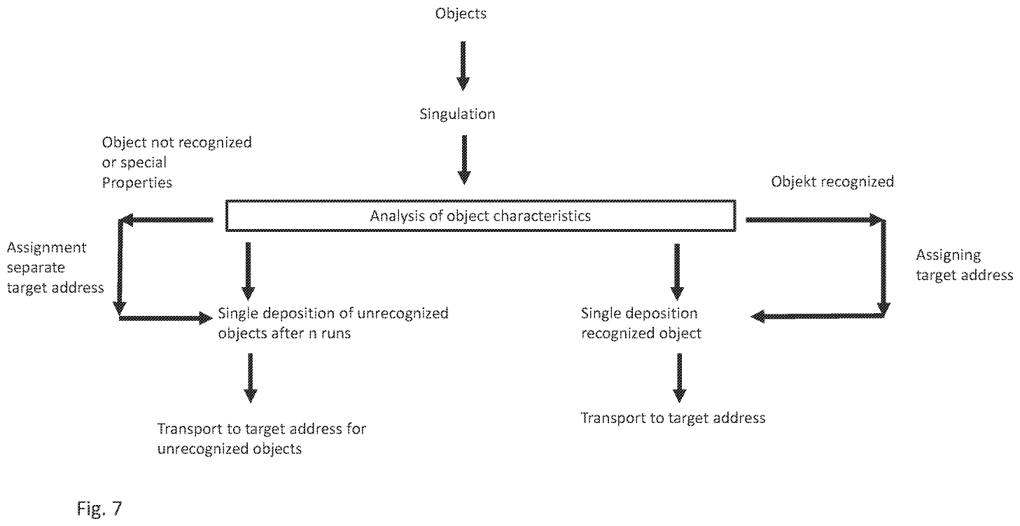

FIG. 7 shows a further modification of the embodiments shown in FIGS. 5 and 6 to the effect that in the case that an object recognition is not possible in the analysis of the object features in so far as no target address assignment is possible by comparison, the affected object is sorted out as undetected or is sorted out for the more extensive analysis of additional object properties. This can have the assignment of a separate target address (standard target address), on the basis of which the correspondingly specified object is transported, for example, to a separate target address for objects without detectable fluorescence code or for objects with unassignable fluorescence code.

The unassignable objects can be analyzed more extensively. For example, the objects can be sighted and manually re-sorted or laboratory analyses can be subjected to. As a result, such objects can possibly also be sorted to a material fraction. Alternatively, such objects can be added again to the process, for example to the singulation step.

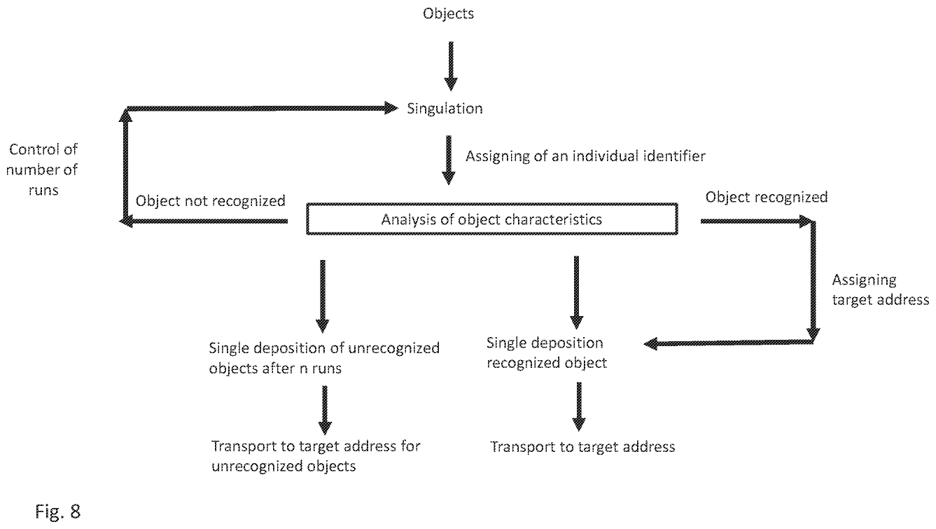

FIG. 8 shows, in a modification of the embodiment shown in FIGS. 5 to 7, the automatic return of undetected objects, wherein it is provided that in the case of a code not detected within the scope of the analysis of the comparison and the corresponding impossibility of assigning a target address, the affected object is added again to the process, for example to the singulation step, so that the previously undetected object again passes through the analysis step. If the recirculated object is supplied in a targeted manner to the already singulated objects, the number of passes can furthermore be counted and a termination criterion can be defined, for example a number of unsuccessful analysis passes, after reaching which the previously multiply unanalyzable object is sorted out as unanalyzable.

The features of the invention disclosed in the above description, in the drawing and in the claims can be essential for the implementation of the invention both individually and in any desired combination.

1. A sorting method comprising the steps of:
a. providing a plurality of objects;
b. singulating the objects;
c. analyzing the singulated objects, wherein at least one material property is respectively detected for the objects;
d. comparing the detected at least one material property with reference material properties stored in a database, to which a target address is respectively assigned, and detecting a fraction affiliation of the objects; and
e. sorting the singulated objects according to the target address assigned to their detected at least one material property via one of the reference material properties in the database.

2. The sorting method according to claim 1, wherein the analyzing comprises electromagnetically exciting a luminescence marker of exactly one of the singulated objects, wherein the marker comprises at least one material that emits with at least one emission wavelength or a plurality of emission wavelengths after the exciting.

3. The sorting method according to claim 1, wherein the analyzing comprises electromagnetically exciting a luminescence marker, wherein a material of the marker comprises at least one of a luminescent material.

4. The sorting method according to claim 1, wherein the analyzing comprises spectroscopy of at least one luminescent material of the singulated objects.

5. The sorting method according to claim 1, wherein the sorting of the singulated objects comprises addressing a support means of a conveyor to which exactly one of the singulated objects is assigned, whereupon the singulated object is supplied to the target address.

6. The sorting method according to claim 1, wherein the addressing comprises driving one of a plurality of independently drivable support means of a conveyor.

7. The sorting method according to claim 1, wherein the analyzing comprises
a) detecting a material property applied to the object or introduced into the object, detecting a fluorescence code and/or a watermark and/or an RFA code and/or a bar code and/or a QR code and/or a symbol and/or a logo and/or an image mark and/or an article number; and/or
b) detecting at least one native material property of the object.

8. The sorting method according to claim 1, wherein after the comparing and before the sorting, a support means of a conveyor to which exactly one of the singulated objects is assigned is assigned the target address linked via the detected at least one material property of the singulated object in the support means and the reference material property.

9. The sorting method according to claim 1, wherein, in the event that during the comparing of the at least one material property with the reference material property stored in the database, no reference material property is detected which is identical to the compared at least one material property, during the sorting of the affected object, a standard address is assigned to the object or the affected object is provided for the renewed singulation and analysis.

10. The sorting method according to claim 1, wherein the analyzing comprises analyzing at least one marker arranged on the object or in the object or a plurality of markers differing in at least one detectable luminescence property, wherein a plurality of markers of a mixture of markers can optionally also differ from one another with respect to their quantity ratio.

11. The sorting method according to claim 1, wherein a printing ink comprising a fluorescent code has been applied to at least one of the provided objects before the providing.

12. The sorting method according to claim 1, wherein a label adhesive comprising a fluorescent code or a label lacquer comprising a fluorescent code has been applied to at least one of the provided objects before the providing.

13. The sorting method according to claim 1, wherein a label or a shrink film has been applied to the object before the providing, which has a fluorescence code in its base material.

14. The sorting method according to claim 1, wherein the object is produced from a base material before the providing.

15. The sorting method according to claim 1, wherein the analyzing comprises determining an intensity for one or more emission wavelengths of a spectrum and/or determining an intensity for one or more emission wavelength ranges of the spectrum and/or determining an intensity ratio between several emission wavelengths or several emission wavelength ranges of the spectrum and/or determining the intensity of an emission spectrum and/or of a dynamic emission behaviour.

16. The sorting method according to claim 1, wherein the analyzing comprises sequentially passing the singulated objects through a tubular or tunnel-shaped detection module, on the inner wall of which at least one sensor for detecting the at least one material property is arranged.

17. The method according to claim 16, wherein the passing comprises passing the singulated objects through the tunnel-shaped detection module in a gravity-driven manner.

18. The sorting method according to claim 1, wherein the analyzing of the singulated objects comprises analyzing with a plurality of mutually independent detection modules, of which the analyzed objects are supplied to a separate sorter per detection module, wherein the sorters feed the same plurality of transport devices according to the target address, and wherein the objects are supplied from the transport devices to one of the target addresses in each case.

19. The sorting method according to claim 1, wherein the analyzing, the comparing and the sorting of the singulated objects is carried out multiple times, wherein in a first analysis step, at least one first material property is detected and in at least one further analysis step, at least one further of the at least one material property is detected, wherein after the first analysis step and a first comparing step, a first part of the target address is assigned and after the at least one further analysis step and the at least one further comparing step, at least one further part of the target address is assigned, and wherein the object is supplied to the target address after passing through all analysis steps and comparing steps and after assigning all parts of the target address.

20. The sorting method according to claim 1, wherein the analyzing, the matching and the sorting of the singularized objects is carried out multiple times, wherein in a first analysis step, at least a first one of the material properties of one of the singularized objects is detected and after the matching a first part of the target address is assigned, wherein the singularized object after the assigning via a transport system is supplied to the target address and/or at least one further detection module for a further analysis step at least one of the first different further material properties is supplied and after the matching a further part of the target address is assigned, and wherein after the assigning of all parts of the target address the object is supplied to the target address.

21. The sorting method according to claim 3, wherein the material of the marker comprises at least one of a fluorescent material, a phosphorescent material, an upconverter or a downconverter.

22. The sorting method according to claim 7, wherein the at least one native material properties property of the object, is one or more of a chemical material composition of the object, a colour, and a shape of the object.

23. The sorting method according to claim 11, wherein the printing ink comprising a fluorescent code has been applied in a partial region of a printing of a label or a shrink film of the object or as a direct printing of the object.

24. The sorting method according to claim 14, wherein the base material is a plastic material which has a material admixture comprising a fluorescence code.

25. A sorting method comprising the steps of:
a. providing a plurality of objects;
b. singulating the objects;
c. analyzing the singulated objects, wherein at least one material property is respectively detected for the objects;
d. comparing the detected at least one material property with reference material properties stored in a database, to which a target address is respectively assigned, and detecting a fraction affiliation of the objects; and
e. sorting the singulated objects according to the target address assigned to their detected at least one material property via one of the reference material properties in the database,
wherein the analyzing, the comparing and the sorting of the singulated objects is carried out multiple times, wherein in a first analysis step, at least one first material property is detected and in at least one further analysis step, at least one further of the at least one material property is detected, wherein after the first analysis step and a first comparing step, a first part of the target address is assigned and after the at least one further analysis step and the at least one further comparing step, at least one further part of the target address is assigned, and wherein the object is supplied to the target address after passing through all analysis steps and comparing steps and after assigning all parts of the target address, and at least a first one of the material properties of one of the singularized objects is detected and after the matching a first part of the target address is assigned, wherein the singularized object after the assigning via a transport system is supplied to the target address and/or at least one further detection module for a further analysis step at least one of the first different further material properties is supplied and after the matching a further part of the target address is assigned, and wherein after the assigning of all parts of the target address the object is supplied to the target address.
